(19) United States
(12) Patent Application Publication
(10) Pub. No.: US 2026/0184594 A1
(43) Pub. Date: Jul. 2, 2026

(54) METHOD FOR RECYCLING USED OR WASTE PERMANENT MAGNETS

(71) Applicant: CAREMAG, Lyon (FR)

(72) Inventor: David Bengio, Villeurbanne (FR)

(21) Appl. No.: 19/130,342

(22) PCT Filed: Nov. 14, 2023
(86) PCT No.: PCT/FR2023/051786

§ 371 Date: May 15, 2025

(30) Foreign Application Priority Data
Dec. 13, 2022 (FR) FR2213230

(51) Int. Cl. C01G 49/06; B09B 3/35; B09B 3/70; C01G 49/00

(52) U.S. Cl. CPC C01G 49/06; B09B 3/35; B09B 3/70; C01G 49/0054

(57) ABSTRACT

This method of recycling used or waste permanent magnets and scrap from the production of such magnets, consists, after having demagnetized said permanent magnets and having reduced them to a powder, in completely oxidizing the latter, and then in submitting the product resulting from this oxidation to a dissolving and finally to a filtering. The oxidation is carried out in two consecutive sub-steps: a first sub-step of partial oxidation at a temperature of no more than 500° C.; and then a second sub-step of complete oxidation at higher temperature, and in particular at a temperature of between 60° and 800° C.

### TECHNICAL FIELD

The invention aims at a novel method intended to recover rare earths present in used or waste permanent magnets, or also present in scrap from the production of such permanent magnets. More specifically, the permanent magnets in question are of neodymium iron (Nd—Fe—B) or also samarium and cobalt (Sm—Co) type.

The method of the invention is part of an approach aiming at satisfying both economic and environmental conditions.

On the economic field, the recovery of rare earths, which may be contained in such magnets by up to 35 wt. %, is a key element, further exacerbated by the current geopolitical context. Indeed, conjugated with an increase in global demand for rare earths, as well as a limited number of rare earth producing countries, likely to generate risks of market procurement with these metals, rare earth recovery is more topical than ever.

On the environmental field, recovery methods known to date are not satisfactory, at least at an industrial scale due to the simultaneous production of solid waste or of liquid effluents.

### BACKGROUND

The different permanent magnet recycling methods known to date comprise two main families, respectively:
so-called short-loop recycling, which reprocesses magnets without dissolving them and by forming new magnets directly from the powder thus recycled, and
so-called long-loop methods, which require dissolving the magnets, and then separating the different rare earths with the aim of producing pure oxides and thus supplying the market of magnets.

The invention pertains to this second family.

These methods include, in particular, pyrometallurgy and/or hydrometallurgy. The hydrometallurgical method is based on the liquid-liquid extraction technique, enabling to recover rare earths from an acid aqueous phase, and typically implementing a total dissolving of the magnet followed by the removal of iron (in the context of neodymium iron boron magnets) by raising the pH. Such hydrometallurgical recycling methods have for example been described in document U.S. Pat. No. 5,362,459 or also in document WO 96/00698. In the latter, the magnet is oxidized by thermal treatment, after which the oxidized powder is dissolved with hydrochloric acid. The iron-neodymium separation is performed by oxalic precipitation of neodymium oxalate, which has a much lower solubility than iron oxalate.

Among the implemented hydrometallurgical methods, there can frequently be observed an excessive acid consumption, and then a base consumption to remove the iron by neutralization.

Other types of hydrometallurgical methods aim at oxidizing, totally or partly, the alloys contained in permanent magnets, with a view to selectively dissolving rare earths, and in particular:
thermal oxidation (high-temperature magnet calcination) enabling to obtain a mixture of iron oxide and of rare earths;
high-pressure hydrothermal magnet oxidation, which enables to obtain hydroxide of rare earths, soluble in an acid medium, and of magnetite, which can be easily separated due to its magnetism.

If, at a laboratory scale, the different provided hydrometallurgical techniques have enabled to perform a selective recycling of rare earths, real difficulties can be observed at an industrial scale.

These include in particular the fact that, during oxidation, temperatures higher than 600° C. are likely to be reached, which may cause the agglomeration and the sintering of part of the material, preventing the obtaining of a homogeneous oxidized phase.

When the temperatures during oxidation are higher than 600-900° C., the forming of a mixed oxide TRFeO₃ (TR=rare earths) can be observed. This oxide is more refractory than rare earth oxides and requires more severe attack conditions, generating a loss of efficiency or a loss of selectivity during the dissolving. The uncontrolled oxidation of the magnet powder results in temperatures capable of exceeding 1,000° C., thus favoring the forming of mixed oxides.

Further, during hydrothermal oxidation, the oxidation kinetics mainly depends on the total gas pressure within the processing chamber (typically an autoclave). Typically, to achieve kinetics acceptable for the implementation of a method at an industrial scale, pressures in the order of from 40 to 200 bars have to be applied, accordingly complexifying the actual recycling plant.

There results from methods implemented to date a real difficulty due to the exothermicity of the oxidation reaction, which is not controlled, and which is likely to generate serious issues during industrial implementation.

The invention provides a method for recycling used or waste permanent magnets, and further scrap from the production of such magnets, implementing such a hydrometallurgical method at an industrial scale and overcoming the disadvantages of methods known to date.

### SUMMARY OF THE DISCLOSURE

According to the invention, this recycling method consists, after having demagnetized said permanent magnets and after having reduced them to a powder, in oxidizing the latter in conditions enabling to improve the rare earth recovery efficiency and the dissolution selectivity over iron or cobalt.

According to the invention, said powder is submitted to a complete oxidation. At the end of this oxidation step, the obtained product is submitted to a dissolving step, and finally to a filtering step.

According to the invention, the oxidation step is carried out in two successive steps:
a first sub-step of partial oxidation temperature of no more than 500° C.,
and then a second sub-step of complete oxidation at a higher temperature, and in particular at a temperature of between 60° and 800° C.

The implementation of these two oxidation sub-steps enables to much more efficiently control the temperature, avoiding agglomeration and sintering problems and limiting the forming of refractory mixed oxide of the type of those previously mentioned.

Typically, in the context of the recycling of neodymium-iron-boron permanent magnets, the product resulting from the first oxidation sub-step has a mostly amorphous structure, and is in particular characterized by the absence of a phase containing rare earths in the zero oxidation state (typically TR₂Fe₁₄B and TRFe₄B), the absence of refractory mixed oxide of TRFeO₃ type, the presence of iron in the form of metallic iron or of iron oxide, in particular magnetite Fe₃O₄.

As a corollary, the product resulting from the second oxidation sub-step has a mostly crystalline structure, and is in particular characterized by the absence of iron or of rare earths in the metallic state, the presence of iron in the form of oxide, mainly hematite (Fe₂O₃), as well as a limited proportion (typically smaller than 10 wt. %) of TRFeO₃-type refractory mixed oxide.

According to an advantageous feature of the invention, there takes place, between the steps of oxidation and dissolving, a step of grinding of the products resulting from the oxidation. This grinding step aims at releasing rare earth oxides outside the iron oxide layer which forms outside the grains. It further enables to accelerate the kinetics of the subsequence dissolving step.

Typically, this grinding step generates the obtaining of particles smaller than or equal to 100 micrometers.

It may further be envisaged to carry out this grinding step under a wet atmosphere, to decrease phenomena of excessive dispersion of fines.

Advantageously, the first oxidation sub-step is carried out at a temperature of between 15° and 500° C., preferably between 40° and 500° C.

In parallel, this first oxidation sub-step may be carried out in air, provided for the temperature to be lower than or equal to 400° C.

However, if this temperature is higher than 400° C., and thus in the range from 400 to 500° C., this sub-step has to take place:
either under a wet inert gas mixture (nitrogen N₂ or argon Ar);
or in air but with an oxygen content of no more than 15% by volume.

This gas may be wet with a water content of between 5 and 50% by volume. If it is chosen to work in the absence of oxygen, the gas necessarily has to be wet to obtain the desired oxidation.

Indeed, if this partial pressure is higher than 50% by volume, said first sub-step may result in too high a temperature and in excessive recondensation at the cold points of the circuit. If said partial pressure is lower than 5% by volume, the progress of the reaction is insufficient to efficiently proceed to the next step.

The duration of this first sub-step is in the range from 10 minutes to 10 hours, preferably from 30 minutes to 2 hours.

According to the invention, the second sub-step of oxidation in air is carried out at a temperature of between 60° and 800° C., preferably between 65° and 750° C., and this, for a time period from 10 minutes to 10 hours, preferably between 30 minutes and two hours.

Ideally, the granulometry of the demagnetized powder undergoing these oxidation steps is made up of fragments in the order of one millimeter, down to a particle size in the order of 4 micrometers. Preferably, this particle size is in the range from 100 to 500 micrometers. Indeed, if this particle size is too low, one can observe an excessive dispersion of fine particles, likely to foul filters and other ducts present or ending up in the furnace within which this operation takes place. If however, this particle size is too significant, the size of the then coarse particles opposes a complete oxidation of the powder, and accordingly alters the efficiency of the method of the invention.

According to another feature of the invention, the dissolving step is carried out in an acid medium, the implemented acid being advantageously selected from the group comprising hydrochloric acid, nitric acid, and sulfuric acid.

Advantageously, the temperature of this dissolving step is from room temperature to 90° C., and preferably between 6° and 90° C. Typically, if this temperature is lower than 60° C., the kinetics of this dissolving step is altered. If however, this temperature is higher than 90° C., an excessive evaporation of water and of the acid implemented can be observed, requiring recondensation, and this complexifying the method.

To optimize the recycling method of the invention, the dosage of acid during this dissolving step plays an important role. Typically, the stoichiometry of the acid is from 1 to 2 with respect to that of rare earths, preferably in the range from 1 to 1.2.

Indeed, if the acid concentration is sub-stoichiometric with respect to rare earths, there is a loss in efficiency of the recycling of the rare earths which are desired to be obtained.

However, if the acid concentration is super-stoichiometric, on the one hand, the quantity of consumed acid is de facto excessive, and on the other hand, more iron than wanted is dissolved, which iron is then present in the form of Fe (II) or Fe (III) ions, which should then be removed by adjustment of the redox potential and of the pH, and as a corollary generating an overconsumption of base. Further, the filtering of the iron thus re-precipitated is relatively less efficient than the filtering of non-dissolved ferric oxide.

The duration of this dissolving step is in the range from 1 to 10 hours, advantageously from 2 to 6 hours.

According to the invention, the oxidation step is implemented within a furnace, and for example:
a static muffle furnace integrating a chamber heated with gas or with electric resistors, in which the powder is loaded into crucibles,
a passage kiln, that is, a heated tunnel in which a crucible containing the powder advance progressively,
a rotary furnace, that is, a tube heated with gas or with electric resistors and in which the powder circulates by the joint effect of the slope imposed to the tube and of its rotation,
a fluidized bed reactor, that is, a reactor containing the powder into which the hot gas is injected at speeds such that said powder is set to motion and has flow characteristics close to those of a fluid.

### BRIEF DESCRIPTION OF THE DRAWINGS

The way in which the invention can be implemented and the resulting advantages will better appear from the following example of embodiment, given as non-limiting indication, in relation with the accompanying drawings.

FIG. 1 is a simplified representation illustrating the different steps of the method of the invention.

FIG. 2 is a simplified representation more specifically illustrating the two oxidation steps of the method of the invention.

### DETAILED DESCRIPTION

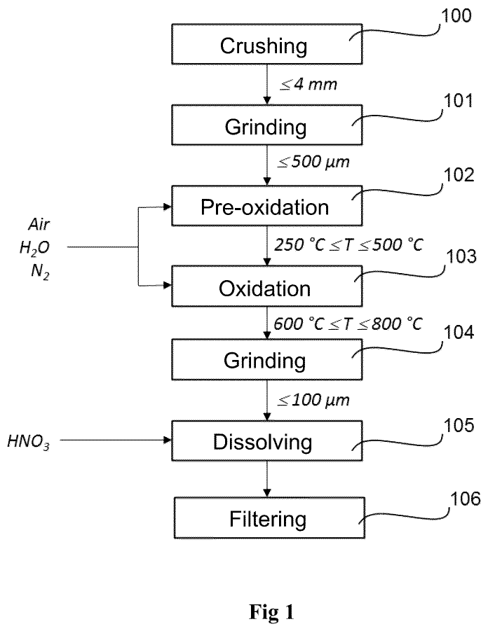

According to the method of the invention, having its main steps schematically illustrated in FIG. 1, the recycling product is typically made of used or waste permanent magnets. Alternatively, it may be made of scrap resulting from the operations of production of such magnets, said scrap also containing rare earths.

These recycling products are first demagnetized. This demagnetization is typically obtained by heating beyond the Curie temperature, and typically 350° C. for Nd—Fe—B magnets.

Then, they are reduced to a powder to typically reach a particle size ideally in the range from 100 to 500 micrometers, in the case in point by a crushing step (100), followed by a grinding step (101).

The powder thus obtained is then submitted to a first sub-oxidation (102), to result in a partial oxidation of the rare earths present in said powder.

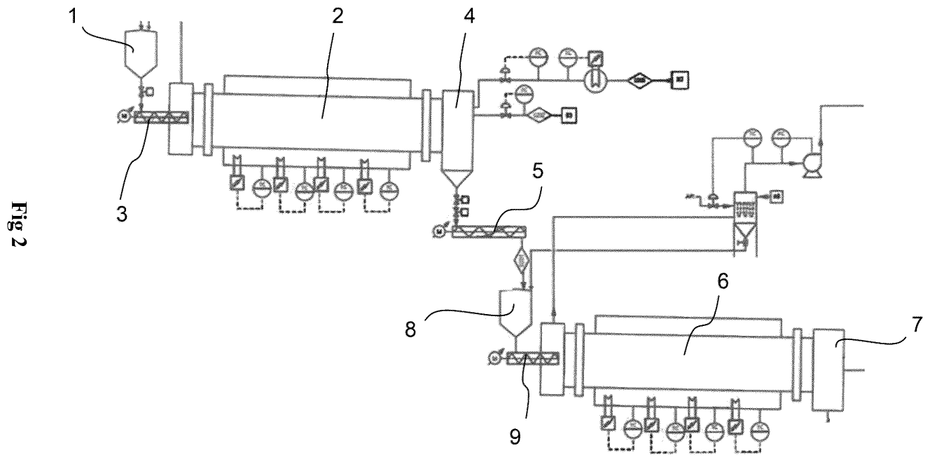

For this purpose, the powder, for example stored in a tank (1) (FIG. 2), is fed to a first furnace (2), typically a static muffle furnace, a passage kiln, a rotary furnace, or a fluidized bed reactor, by means of a worm screw (3).

Within this first furnace, a gas is present, and for example a mixture of nitrogen or argon, and a water content of between 5 and 50% by volume.

The temperature in this first furnace is typically of between 25° and 500° C., and the duration of the treatment within this furnace is ideally of between 30 minutes and two hours.

This wet gas may be replaced with air. In this configuration, the temperature required in the furnace then is at most 400° C., and the treatment time then ideally is of between 30 minutes and two hours.

Whatever the gas present in the furnace, the aim is the oxidation of the rare earths present in the powder.

Once this first oxidation sub-step (102) has been carried out, the powder will then undergo a second oxidation sub-step (103), aiming at achieving complete oxidation of the rare earths contained in said powder.

For this purpose, the powder stored in a hopper (4) at the outlet of the furnace (2), is conveyed, here again by means of a worm screw (5), to a buffer tank (8).

During this second oxidation sub-step, the powder, stored in the buffer tank (8), is conveyed by means of a worm screw (9) to a furnace (6), within which it is then submitted to a new treatment, this time limitingly in air, at a temperature of between 50° and 800° C., preferably between 60° and 800° C. This furnace (6) may be of same nature as furnace (2). The duration of this treatment is also of between thirty minutes and two hours.

The aim of this second sub-step is to achieve complete oxidation of the elements present in the powder.

The latter is then stored in a tank (7).

It is then submitted to a grinding (104), particularly in wet conditions, to obtain a particle size smaller than or equal to 100 micrometers.

Then, the powder thus reduced is then submitted to a dissolving step (105).

This dissolving step takes place in an acid medium, advantageously with nitric acid, under a temperature of between 6° and 90° C. For this purpose, the powder is conveyed within a reactor provided with an agitator.

The acid dosage is such that it provides a stoichiometry of between 1 and 1.2 with respect to rare earths. Actually, due to the relative uncertainty as to the effective rare earth content in the powder, the dissolving is driven by varying the pH. For this purpose, the pH at equilibrium, that is, a few hours after the beginning of this step, is in the range from 0 to 4, preferably from 0.5 to 2.

The liquid/solid ratio is in the range from 1 to 5, preferably from 1.5 to 3.

The duration of the stay in the dissolution reactor is of between 1 and 10 hours, preferably between 2 and 6 hours.

It should be specified that the entire method can be applied in the same way whatever the rare earths composition of the magnets. The efficiency or yield is identical for all rare earths which have the same behavior.

After the dissolving, a filtering (106) is performed, particularly by means of a press filter, so as to separate rare earths, then in the form of nitrates in solution, and oxide(s), in the case in point iron oxides.

The following examples have been carried out from NdFeB magnets having the following composition:

| Nd | Pr | Dy | Tb | Fe | B | Al | Co | Cu | Zn |
|---|---|---|---|---|---|---|---|---|---|
| 24% | 2.7% | 2.3% | 0.4% | 61% | 0.9% | 0.4% | 1.3% | 0.2% | 0.3% |

The rare earth yield is calculated like a yield by mass on the sum of the Nd, Pr, Dy, and Tb elements.

### Example 1

NdFeB magnets are reduced to a powder (d₁₀₀<250 μm) and the powder is processed in a rotary furnace for 4 hours at 500° C. under a wet nitrogen flow (450 l/h at 4% H₂O). The mass gain at the end of the treatment is 12%. By mass gain, there is meant the (final mass−initial mass)/initial mass ratio.

The powder thus partially oxidized is processed again in a rotary furnace for 2 hours at 700° C. under an air flow. The cumulated mass gain at the end of this treatment is 30%.

The obtained powder is placed in suspension in water, and nitric acid is added with a 10% mol. excess with respect to the rare earths contained in the powder.

This dissolution occurs at 90° C. with a liquid/solid ratio of 2.

After filtering and cleaning of the cake resulting from this filtering, the dissolution efficiency, that is, the molar quantity of rare earths to the molar quantity of rare earths in the initial powder for each rare earth is 95%. The total concentration of rare earths is 132 g/l and the Fe concentration is 0.01 g/l, that is, a TR/Fe mass ratio in solution of 13,200. The final pH is 0.5.

### Example 2

NdFeB magnets are reduced to a powder (d₁₀₀<250 μm) and the powder is processed in a muffle furnace with the following temperature ramp:
temperature rise to 400° C. within 1 hour in air;
then treatment for 4 hours at 400° C. in air;
temperature rise to 600° C. within 1 hour in air in the furnace (6);
then treatment for 4 hours at 600° C. under an air flow.

The obtained powder is roughly ground to break agglomerates. The mass gain at the end of this treatment is 27%. The powder is placed in suspension in water and hydrochloric acid is added with a 220% molar excess with respect to the rare earths contained in the powder. This dissolution occurs at 90° C. with a liquid/solid ratio of 5. After filtering and cleaning of the cake, the efficiency of dissolution of each rare earth is 95%. The total rare earth concentration is 44 g/L and the Fe concentration is 54 g/L, that is, a TR/Fe ratio of 0.81. The final pH is 3.0.

### Example 3

NdFeB magnets are reduced to a powder (d₁₀₀<250 μm) and 15 kg of powder are processed in a fluidized bed reactor. The powder is first fluidized by a nitrogen flow and water is injected to reach a temperature close to 500° C.

The water supply is then cut off and the nitrogen flow replaced with an air flow up to a 850° C. temperature. This is the second oxidation sub-step (103).

The obtained powder is roughly ground to break agglomerates. The mass gain at the end of this treatment is 30%. The obtained powder is placed in suspension in water, and nitric acid is added with a 20% excess with respect to the rare earths contained in the powder. This dissolution occurs at 90° C. with a liquid/solid ratio of 2. After filtering and cleaning of the cake, the efficiency of dissolution of each rare earth is 93%. The total rare earth concentration is 140 g/l and the Fe concentration is 19 g/l, that is, a TR/Fe mass ratio of 7.4. There thus is a slight loss of yield, but above all a very strong selectivity decrease.

It can thus be observed that by implementing the method of the invention, and particularly an oxidation of the powders in two provided steps, and within the indicated temperature ranges, yields of 95% and an excellent selectivity are obtained.

Further, when nitric acid is replaced with hydrochloric acid, a high iron concentration is kept despite a final pH of 3.0. Nitric acid is thus preferred since its implementation contributes to optimizing the rare earths/iron selectivity, iron being stable in solution, even at a relatively high pH.

As a corollary, when the oxidation temperature is too high (example 3), there is a slight loss of yield, but above all a loss of selectivity.

1. A method of recycling used or waste permanent magnets and scrap from the production of such magnets, consisting, after having demagnetized said permanent magnets and having reduced them to a powder, in completely oxidizing the latter, and then submitting the product resulting from this oxidation to a dissolving and finally to a filtering, wherein the oxidation is carried out in two consecutive sub-steps:
a first sub-step of partial oxidation at a temperature of no more than 500° C.;
and then a second sub-step of complete oxidation at a temperature of between 60° and 800° C.

2. The method of recycling permanent magnets according to claim 1, wherein there takes place, between the steps of oxidation and dissolving, a step of grinding of the products resulting from the oxidation.

3. The method of recycling permanent magnets according to claim 2, wherein the grinding step generates the obtaining of particles having a particle size smaller than or equal to 100 micrometers.

4. The method of recycling permanent magnets according to claim 2, wherein the grinding step is carried out under a wet atmosphere.

5. The method of recycling permanent magnets according to claim 1, wherein the first oxidation sub-step is carried out at a temperature of between 15° and 500° C.

6. The method of recycling permanent magnets according to claim 1, wherein the first oxidation sub-step is carried out in air with a temperature at most equal to 400° C.

7. The method of recycling permanent magnets according to claim 1, wherein the first oxidation sub-step is carried out under a wet inert gas mixture (nitrogen N₂ or argon Ar).

8. The method of recycling permanent magnets according to claim 1, wherein the first oxidation sub-step (102) is carried out in air but with an oxygen content of no more than 15% by volume.

9. The method of recycling permanent magnets according to claim 6, wherein the gas is wet with a water content of between 5 and 50% by volume.

10. The method of recycling permanent magnets according to claim 1, wherein the duration of the first oxidation sub-step is in the range from 10 minutes to 10 hours.

11. The method of recycling permanent magnets according to claim 1, wherein the second sub-step of oxidation in air is carried out at a temperature of between 50° and 800° C., for a duration from 10 minutes to 10 hours.

12. The method of recycling permanent magnets according to claim 1, wherein the demagnetized powder is made up of fragments in the order of one millimeter, down a particle size in the order of 4 micrometers.

13. The method of recycling permanent magnets according to claim 1, wherein the dissolving step is carried out in an acid medium, the implemented acid being advantageously selected from the group comprising hydrochloric acid, nitric acid, and sulfuric acid.

14. The method of recycling permanent magnets according to claim 13, wherein the dissolving step is carried out at room temperature up to 90° C.

15. The method of recycling permanent magnets according to claim 13, wherein the stoichiometry of the implemented acid is from 1 to 2 with respect to the rare earths contained in the magnets.
